(19) United States
(12) Patent Application Publication
(10) Pub. No.: US 2015/0022536 A1
(43) Pub. Date: Jan. 22, 2015

(54) HEIRARCHY AND HINT BASED RENDERING PIPELINE SELECTION

(71) Applicant: Google Inc., (US)

(72) Inventors: Romain P. Guy, Millbrae, CA (US); Dianne K. Hackborn, Mountain View, CA (US)

(73) Assignee: Google Inc., Mountain View, CA (US)

(21) Appl. No.: 13/735,626

(22) Filed: Jan. 7, 2013

Related U.S. Application Data
(60) Provisional application No. 61/583,528, filed on Jan. 5, 2012.

(51) Int. Cl. G09G 5/00

(52) U.S. Cl. CPC G09G 5/003
USPC 345/522

(57) ABSTRACT

Methods, systems, and apparatus, including computer programs encoded on a computer storage medium, for receiving a request for rendering a graphical object associated with a component of a computer system, the component including a request that hardware accelerated rendering be used in conjunction with the component. A hint is referenced, the hint including a condition under which hardware accelerated rendering should not be used. The graphical object is rendered without hardware accelerated rendering based on a determination that the condition of the hint is met with respect to the request.

### CROSS-REFERENCE TO RELATED APPLICATION

This application claims priority to U.S. Provisional Application Ser. No. 61/583,528, filed on Jan. 5, 2012, the entire contents of which are hereby incorporated by reference.

### TECHNICAL FIELD

This document relates to components of computer operating systems, including components for graphical rendering.

### BACKGROUND

Computer operating systems perform a number of functions, including serving as a bridge between computer hardware and computer applications that run on the operating systems. Modern computer operating systems also provide basic graphical user interfaces (GUIs) by which users can interact with components of the operating system in more intuitive manners.

In some computing systems, the resources available for rendering graphics may include hardware acceleration, which when utilized may increase system performance and allow for superior graphics rendering by providing dedicated hardware, such as a graphics processing unit (GPU), to more quickly process code requiring significant computational resources. A system may therefore provide access to hardware acceleration for applications that execute on the system.

However, third party applications, particularly multi-platform applications, may not be fully compatible with hardware acceleration on a specific device. Typically when the hardware encounters an error in rendering an application, the application crashes, which causes consternation for a user. This can discourage the user from using the application, and can discourage application developers from taking advantage of the hardware acceleration feature at all.

Adapting all components of an application to be fully compatible with a new graphics system can be costly for a developer and may not always be cost-efficient. In contrast, adapting specific components that may take greatest advantage of a new system, such as those components that would most benefit from hardware acceleration, may be worth the development costs, but provides no benefit in a traditional system that makes hardware acceleration decisions on a per-application basis.

### SUMMARY

This document describes systems and techniques that may be used for managing objects within a graphical user interface for a computer operating system.

In certain examples below, application developers and a host system can control hardware acceleration using hints. Such hints can be used to disable hardware rendering for applications that request hardware acceleration if it matches pre-defined criteria.

In the same or other examples, hardware acceleration can be applied according to a hierarchical organization of visual elements displayed by a computing device. For example, an application be represented by one level of a hierarchy, and graphical elements by which a user interacts with the application (e.g., a sub-window where streaming video is played, such as on a television that is shown as a part of a videogame) may be represented at lower levels of the hierarchy. Each level may also have multiple visual elements in it, and each of those elements may have sub-elements at even lower levels of the hierarchy. Control of whether hardware accelerations is used, and how it is used, can be controlled for particular visual elements or for all elements across a particular level in the hierarchy. Such control defined for one element or one level may then be propagated automatically via inheritance to lower levels of the hierarchy or to child visual elements, as appropriate. A developer can also write an application to override the automatically-applied inheritance state of a particular level just described, a particular branch of the hierarchy, and/or a particular visual element defined in the hierarchy. The manner in which such visual elements or hierarchy levels are rendered may be controlled, for example, by the use of flags, where a control flag can be assigned for each hierarchy level, and can be read by the system to identify the manner in which elements at that level are to be rendered. Also, the flags or other controls may be defined in a manifest for a particular application, such as a standard XML manifest that is provided by a developer for use with the developer's application.

In one embodiment, a computer-implemented method includes receiving a request for rendering a graphical object associated with a component of a computer system, the component including a request that hardware accelerated rendering be used in conjunction with the component. A hint is referenced and includes a condition under which hardware accelerated rendering should not be used. The graphical object is rendered without hardware accelerated rendering based on a determination that the condition of the hint is met with respect to the request.

In another embodiment, a computer-implemented method includes receiving request for rendering a first and second graphical object associated with a component of a computer system. The first and second graphical objects are each also associated with a different subcomponent of the component. A hardware accelerated rendering signal of the component is identified, the signal requesting either that graphical objects associated with the component be rendered with hardware acceleration or that graphical objects associated with the component be rendered without hardware acceleration. The first graphical object is rendered in accordance with the hardware accelerated rendering signal of the component. In contrast, the second graphical object is rendered contrary to the signal of the component, due to the identification of hardware accelerated rendering override signal of the subcomponent associated with the second component. The override signal requesting that graphical objects associated with the subcomponent be rendered contrary to the hardware acceleration setting specified by signal of the component.

In some implementations, the component is an application, and the first and second subcomponents are each either an activity, a window, or a view of the application. Alternatively, the component may be an activity of an application, and the first and second subcomponents are each either a window or a view of the activity. Further in the alternative, the component may be a window of an activity within an application, and the first and second subcomponents are views of the window.

In yet another implementation, a computer-implemented method is disclosed that comprises identifying a visual element to be display on a graphical user interface, identifying a hierarchical organization that defines rendering processes for the visual element, identifying the state of a flag in the hierarchical organization that defines whether hardware acceleration should be used for the visual element, and causing the visual element to be rendered by a computer graphics system according to the identified state of the flag. The flag that defines whether hardware acceleration should be used for the visual element may be defined for the visual element itself, for a hierarchy in which the visual element is located in the hierarchy, for another visual element that is a parent of the visual element, or for a level in the hierarchy that is above the level in which the visual element is located. Such flag may be set automatically be rules defined for a system, and can be overridden by specific commands provided by a developer regarding how visual elements or hierarchical levels are to be rendered for the developer's particular application or applications. The developer may defines such flags and/or such overrides in a manifest that the developer distributes with other files for executing the application, and can be provided to a device at the time the application is downloaded, such as via an on-line application marketplace.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows a diagram of a visual element hierarchy with hardware acceleration settings.

FIG. 2 is a flowchart of an example method for determining hardware accelerated rendering settings.

FIG. 3 is a flowchart of an example process for rendering a graphical object.

FIG. 4 shows aspects of an example device for displaying content, which may be used with the techniques described here.

FIG. 5 shows an example of a generic computer device and a generic mobile computer device, which may be used with the techniques described here.

### DETAILED DESCRIPTION

This document describes mechanisms by which an operating system may manage interactions with graphical objects that can be viewed by, and/or manipulated by, a user of a computing device. The operating system may provide access to hardware resources for certain graphical processes in order to provide graphics acceleration for those processes. The hardware resources may be allocated to different graphical processes in order to process graphical elements from different sources, and may manage the interaction between concurrently running graphical processes (e.g., which may each be controlled by the same or different software applications).

Each process (e.g., a process for carrying out a software application) may include a variety of different graphical elements, which may be arranged in a hierarchical fashion. In some implementations, an application may have activities. An activity may include windows. A window may have multiple views. Although this example represents one set of objects that may have inheritance and other useful properties, it will be understood that this structured hierarchy is only exemplary.

Graphical components may include hardware acceleration settings, which are signals relevant to the determination of whether or not to use hardware accelerated rendering. These settings may applied to each level of the hierarchy, and may be inherited by the lower levels from parent level to child level. For example, a hardware acceleration setting at the application level may be inherited at the activity, window, and view levels. A hardware acceleration setting at the activity level may be inherited at the window and view levels. A hardware acceleration setting at the window level may be inherited by each of the window's views.

The system can selectively choose whether to render graphical components at each of these levels using hardware acceleration. In determining whether to use hardware accelerated rendering, in addition to the settings provided by the components themselves, the system consults hints, which include rules for using or not using hardware accelerated rendering based on the properties of the components or the conditions of the system. These hints provide additional signals that are considered in addition to, and may override, hardware acceleration settings associated with graphical components.

Because the system does not always choose to follow the hardware acceleration settings given in each graphical components, these settings may also be considered to be requests for hardware acceleration enabling or disabling for the component. Whether the term used is “setting”, “request”, “signal”, or the like, the existence of other factors in determining whether to render graphical objects using hardware acceleration (as opposed to other modes of rendering) implies that the setting associated with the component is not always determinative.

By allowing hardware accelerated rendering choices to be made hierarchically for each component, developers can choose to selectively adapt only some components of an application for hardware rendering. The system can also make compatibility determinations at each level and can disable hardware rendering for some components without disabling hardware rendering for an entire application. By allowing the setting to override hardware acceleration signals based on other system considerations, certain unwise settings choices by developers may not be fatal to an application's ability to run.

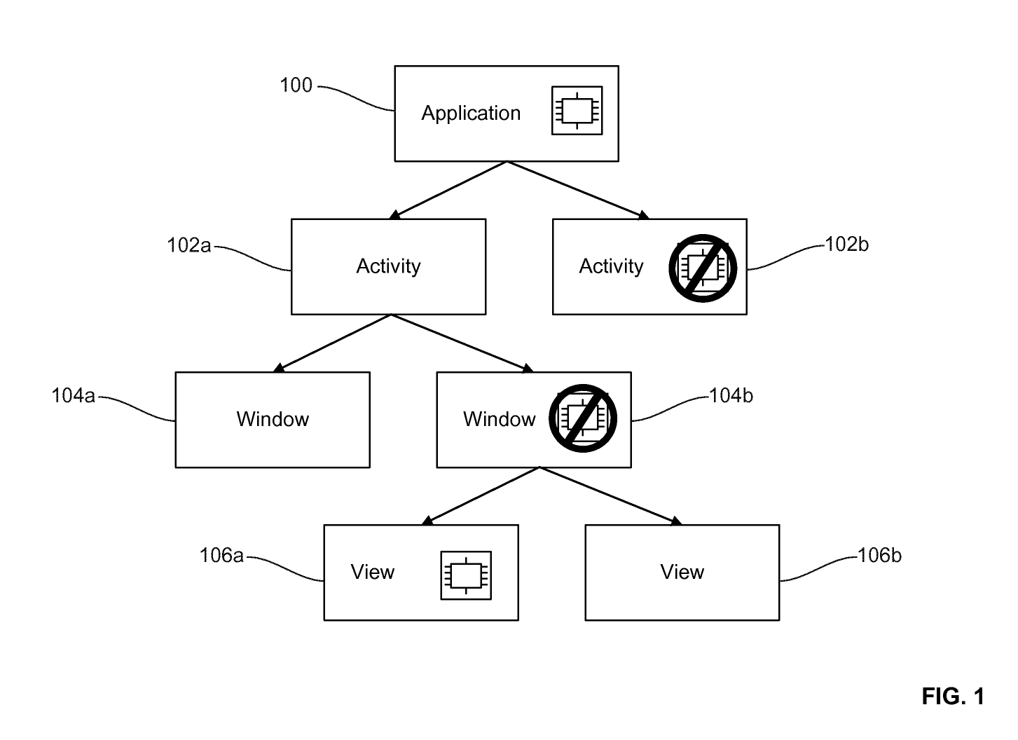

FIG. 1 illustrates an application 100 showing a hierarchy of graphics components from the application level down, wherein the system has enabled hardware acceleration rendering for some components but not others. As shown in FIG. 1, an application may be a graphical component. Each application may include one or more activities, each of which manage a specific user interaction, such as dialing a phone, taking a photo, sending an email, or viewing a map. Each activity may include one or more windows, representing displays that may be presented to the user in aid of performing the activity. Each window may include one or more views, which are particular display configurations of the window including a particular layout of graphic elements.

Other systems may have some or all of these components using varying terminology, or may have different graphical elements that nonetheless observe a hierarchy as herein described. Although the examples herein use specific terms for specific components, implementations are not limited to those graphical elements and may apply to a variety of computing systems with hardware accelerated rendering.

The application 100 has hardware accelerated rendering enabled for the application as a whole, as illustrated in FIG. 1 by the presence of a GPU chip icon. This represents a setting at the application level indicating that, when responding to requests to render graphical elements associated with this application 100, the use of hardware resources to aid in rendering is requested. The application 100 may be an executed application, a background process, a widget, a system process, or any other executable process associated with graphical objects to display and having subcomponents.

Two of the application's activities 102a and 102b are shown. Each activity may represent a different instance of an activity object and may involve a different anticipated action on the part of a user. Each activity may have an individual setting for enabling or disabling hardware accelerated rendering with respect to graphical objects associated with that activity. Additionally, an activity may not have an individual setting. Any activity without an individual setting may, as herein described, inherit a setting from its parent application. In certain optional implementations, an activity that has a setting may have that setting overridden by a setting for a parent element, where such an override is defined for the parent.

In the example shown in FIG. 1, the activity 102a has not been assigned an explicit signal, and so inherits the setting from its parent application 100. Because the parent application 100 has hardware acceleration enabled, the activity 102a is also considered to have hardware acceleration enabled.

However, activity 102b overrides the inherited state by specifically having hardware acceleration disabled, as shown by the GPU chip icon with a prohibition sign in FIG. 1. Unlike the application 100 and activity 102a, the hardware acceleration setting for the activity 102b indicates that it does not request hardware resources when rendering graphical objects associated with activity 102b. Windows and views included under the activity 102b, not shown, also inherits this setting unless a lower-level setting overrides it, and would therefore by default not request hardware resources for rendering.

The activity 102a further includes at least two windows, shown in FIG. 1 as windows 104a and 104b. Because the activity 102a does not have an explicit setting and is inheriting a hardware acceleration enabled setting, the graphics associated with the windows of activity 102a will also request hardware acceleration unless they include an explicit signal to the contrary.

The window 104a does not have an explicit setting. The window 104a therefore inherits hardware accelerated rendering from parent application 100 through parent activity 102a, and will be treated as requesting hardware resources when graphical objects associated with the window 104a are rendered. Any views of the window 104a, not shown, will also be considered to have a hardware enabled setting unless another setting is explicitly included.

The window 104b has a setting, again shown by a GPU chip icon with a prohibition symbol, to disable hardware rendering for graphical objects within that window 104b. As with the other settings, this setting may be established by a flag that is set in a manifest for the application, and that is monitored by the system components that are responsible for assigning rendering functions to the system components. This overrides the signal from its parent application 100 that hardware rendering be enabled.

The views for window 104b include views 106a and 106b. By default, these views 106a and 106b inherit hardware acceleration settings from their parent window 104b, and so have hardware acceleration disabled. Thus, view 106b has hardware acceleration disabled by inheritance. In contrast, view 106a overrides the inheritance in order to specifically enable hardware accelerated rendering, as shown by the GPU chip icon in FIG. 1.

FIG. 1 therefore illustrates the existence of inherited hardware acceleration settings at each level of the application hierarchy as well as the ability to override those settings at any level. The settings may be any appropriate variable or signal in the system, and may differ between different levels. For example, in one implementation, applications and activities may use a flag defined in their XML manifests, windows may use a flag associated with a window manager object, and views may use a property of the view object. Implementations may be language- and context-specific; in some implementations, settings may be accessed from a centralized library or registry rather than directly associated with each component.

The example illustrated in FIG. 1 uses standard, direct inheritance relationships that preference proximity—that is, the most immediate parent with a setting has the setting honored. Additionally, inheritance is symmetrical, allowing either an enabling or a disabling signal to be inherited at any level. In alternative implementations, one or both these rules may not be followed.

In some implementations, a setting at a specific level may be inherited by all components at lower levels unless it is explicitly overridden. For example, if the activity level has hardware acceleration enabled, then all windows and views below the activity level may have hardware acceleration enabled unless that specific window or view enables hardware acceleration in an explicit setting. Using the application 100 from FIG. 1, under these rules, the view 106 would be considered to have the hardware acceleration enabled setting rather than the disabled setting as described above, and the explicit signal requesting hardware accelerated rendering shown for the view 106a would be redundant.

In some implementations, certain settings at a given component level may not be overridden at a lower level, but instead automatically inherit. For example, disabling hardware rendering at the window level may be read as a request to disable hardware rendering for any views associated with that window. Using FIG. 1, then, the view 106a would have disabled hardware acceleration under this rule, as it would inherit this setting from the window 104b and be afforded no opportunity to overrule it. This controlling inheritance may not be symmetrical; for example, a view of a window with hardware acceleration enabled may still be checked to determine if the view has hardware acceleration disabled, even though the views of a window with hardware acceleration disabled are not checked for enabled hardware acceleration at the view level.

In some circumstances, signals associated with components of an application, such as those packaged with an application supplied by a third-party developer, may be considered to be requests rather than directly used as settings. These requests may represent only one of several considered factors in determining whether a certain graphical component is rendered using hardware acceleration. Other factors may include the rules associated with supplied hints, the capabilities of the operating system and device, the current usage of rate and availability of hardware resources, and user-controlled preference settings.

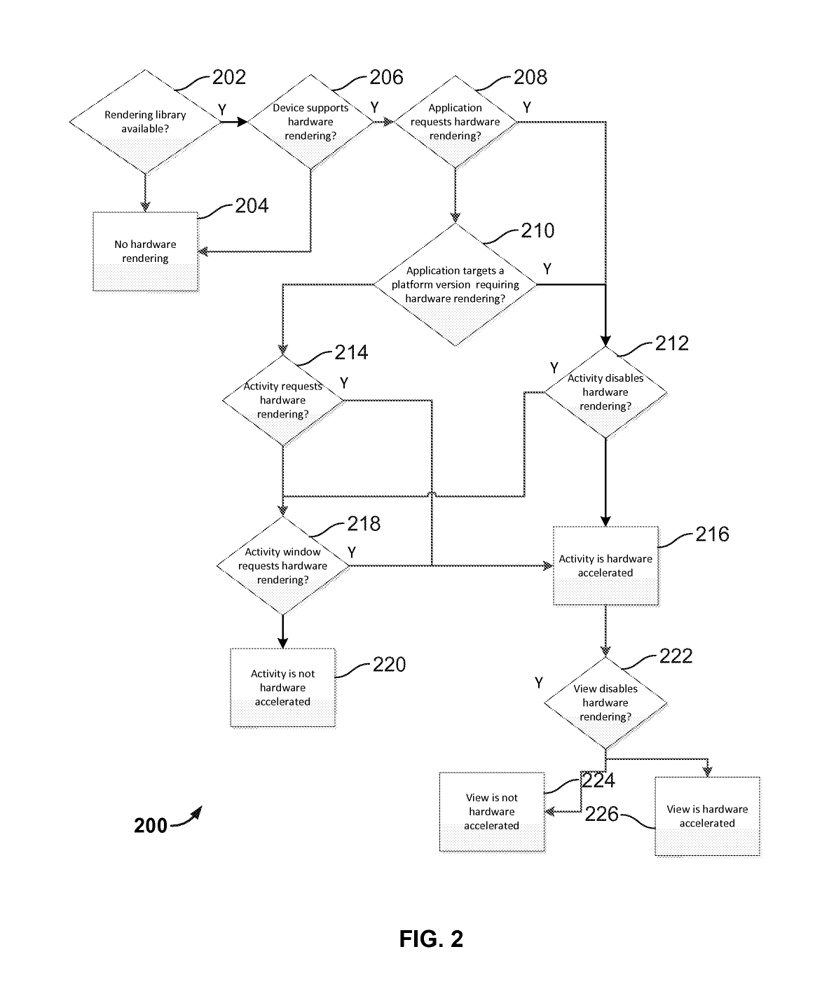

FIG. 2 illustrates a process 200 by which a determination can be made as to which components within an application to accelerate. The process 200 illustrated in the flowchart of FIG. 2 is exemplary only, and illustrates one way in which determinations for hardware accelerated rendering may be made in the context of a specific operating system and device.

The presence of a specific rendering library required for hardware rendering is sought (202). The absence of this rendering library indicates that the system is not configured to render graphics using hardware acceleration, and so no hardware rendering will occur during the instant run (204). This step may be useful when testing or running applications on emulators or other nonstandard platforms not configured to use the hardware rendering engine, as the application immediately falls back to software rendering without making further queries. Because the absence of the rendering library makes it impossible for the system to successfully use hardware resources to render graphical objects, no examination of further steps or settings is required.

Having determined that the appropriate rendering library is present, the system also checks as to whether hardware rendering is compatible with the device upon which the system is running (206). As above, the operating system running on unexpected devices, such as in porting or emulation may not have hardware resources configured for use in rendering graphics associated with the instant process. Devices having damaged, altered, or removed hardware resources may also be physically unable to use those resources for graphics acceleration. If the device does not include the appropriate hardware or the hardware is not available, then hardware acceleration is of course also offline (204).

Having determined that the system and device support hardware acceleration for at least some applications, the specific parameters of the graphical components to be rendered are examined. The example again assumes an application having an activity, which in turn has a window with a view.

The system determines whether the application requests hardware rendering (208). If no setting is found at all for the application, the default may vary according to implementation. In some cases, no explicit signal at the application level is processed as a request for hardware accelerated rendering (“Y” branch of decision block 208); in other cases, it is processed as a request not to use hardware accelerated rendering (“N” branch of decision block 208).

If the application does not request hardware rendering (“N” branch of decision block 208), then a check is performed to see if the application nonetheless targets a platform version requiring hardware rendering (210). This setting may override the explicit or default signal at the application level. An application that specifically targets a version of the platform requiring hardware rendering may be seen as an implicit request for hardware rendering, and in any event the system may treat such an application as having this signal.

If the application does request hardware accelerated rendering or targets a platform version requiring hardware accelerated rendering, then hardware acceleration is enabled at the application level. The system then checks the activity for an override. The activity is examined to see if hardware acceleration is disabled at the activity level (212). This obeys the inheritance rules discuss above, in that the signal at the application level will be used unless it is contradicted by the signal at a lower level.

Alternatively, if the application does not request hardware rendering and also does not target a platform version requiring hardware rendering, then hardware acceleration is not presumed to be enabled at the application level. The activity is examined to see if an override therefore exists in the other direction—that is, if hardware accelerated rendering is enabled at the activity level (214).

Both steps 212 and 214 therefore check to see if a signal exists at the activity level that contradicts the inheritance of the hardware acceleration setting from the application level as described above. The “N” branches of these two steps represent a lack of override at the activity level of the signal at the application level, while the “Y” branches of these two steps (which cross over each other, each to join the “N” branch from the other step) represent an override of the application signal.

In some implementations, such as in the example process 200 illustrated by the flowchart of FIG. 2, if the activity disables (or does not request) hardware rendering, then the system checks to see whether the activity window requests hardware rendering (216). This provides an override for the activity signal at the window level. Only if the activity window also does not request hardware rendering is the activity not hardware accelerated (218). The activity window therefore may by default inherit the activity signal, but a hardware acceleration enable setting at the window level may cause the activity to be hardware accelerated (220).

In contrast, if the activity requests (or does not disable) hardware rendering, then the activity is hardware acceleration enabled (216). No item in the flowchart provided for the process 200 gives an override for this signal at the window level. Following the process 200 provided, an override signal at the window level to disable hardware accelerated rendering will have no effect on the hardware acceleration settings for a graphical element.

If the activity is determined to be hardware acceleration enabled, the view is then checked to see if hardware acceleration is disabled at the view level (222). This provides an override capability at the view level to disable hardware accelerated rendering that is otherwise enabled at the parent levels. If the view has an explicit setting to disables hardware accelerated rendering, then this signal prevails and the view is rendered using dedicated hardware resources (224). Otherwise, the system uses hardware accelerated rendering with graphical objects associated with the view (226).

Note that a decision block similar to the view override decision block 222 is not present in the flowchart of FIG. 2 below block 218—that is, upon determining that the activity is not hardware accelerated and finding no override at the window level, the process 200 does not further check the view level for an explicit signal enabling hardware acceleration.

As illustrated by the process 200, some implementations give the flexibility for some but not all permutations of hardware acceleration settings. The above process 200 provides complete flexibility to change the default setting inherited from the application level at the activity level. In contrast, the window signal is only consulted for a request to enable hardware rendering when it is otherwise disabled at the activity level, not to disable hardware rendering. The view signal is only consulted to disable hardware acceleration if enabled at the activity level. This means that certain override settings, even if present may be ignored by the system in different implementations. Various implementations may heed or ignore different signals for hardware acceleration, permitting flexibility at the points in the hierarchy where it provides the greatest benefit.

In some system builds that have limited flexibility, graphical components may only have properties that reflect their actual flexibility; for example, in the above process 200, window objects may have only a flag representing a request for enabling hardware rendering, and no flag representing a request for disabling hardware rendering. By this and similar tools, data objects can be configured such that unused signals are unlikely to be relied-upon by developers.

In addition to the factors and determinations illustrated above with respect to the process 200, a graphics system for rendering graphical objects may include a number of hints, each representing pre-defined criteria under which hardware acceleration is presumptively disabled, regardless of a request or signal otherwise associated with a component of the system. For example, an application owned by a system process is not rendered using acceleration. As another example, an application belonging to a persistent process is also not rendered using acceleration.

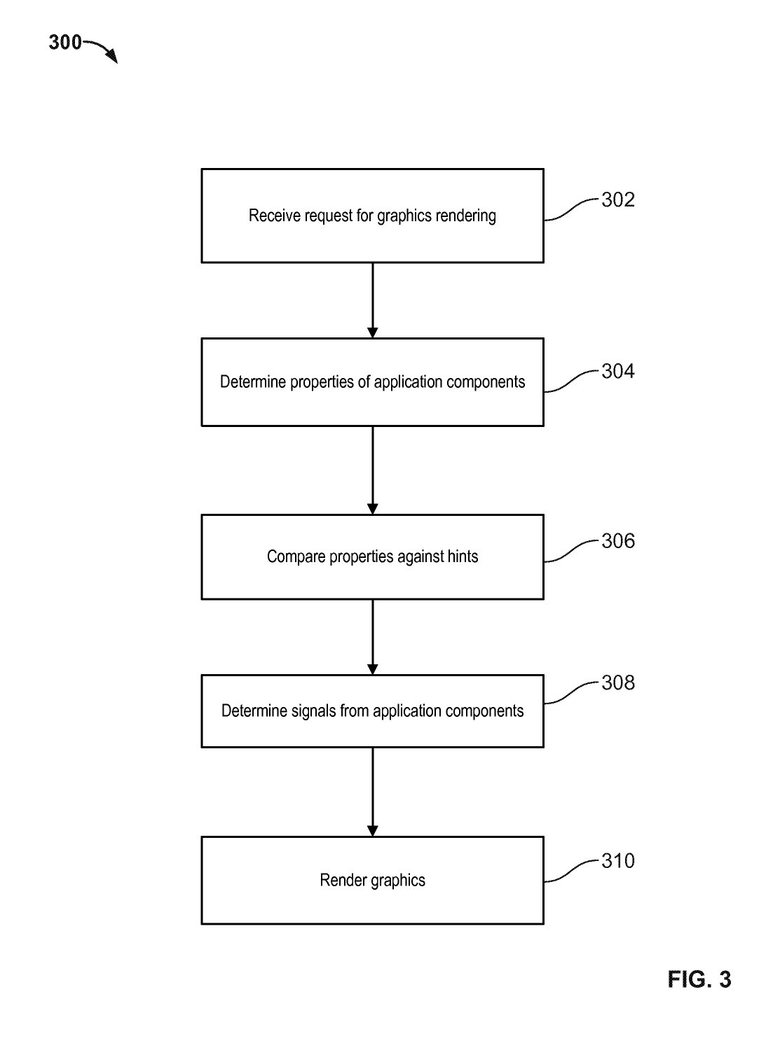

FIG. 3 shows a flowchart illustrating a process 300 which uses both hints and hierarchy settings in order to determine whether to use hardware accelerated rendering.

The graphics system receives a request to render a graphical object (302). The object will typically be associated with an application and specific components of the application, including a specific activity, window, and view. Although the process 300 is explained in terms of evaluating any signal or setting in a later step, the request submitted to the graphics system may itself include a request to enable or disable hardware acceleration with respect to the object.

The properties of the components associated with the request are identified (304). These properties may again be associated with the request; alternatively, the relevant properties may be already established in the system, especially if these rendering processes occur in a known application context. In some implementations, one or more of the properties may reflect the application's relationship to the device or operating system. Which properties are identified may depend on which matter for the rules included in the hints.

The identified properties are compared against the hints to determine if the software is disabled upon the basis of the hints (306). As described above, the hints may involve properties of the application with respect to the device or operating system; persistent applications or system applications may not be hardware accelerated, regardless of the setting specific to those applications. In some implementations, one or more of the additional factors illustrated above with respect to FIG. 2, such as the presence or absence of a certain rendering library, may also be evaluated along with checking the hints.

If the hints result in disabling hardware rendering, then hardware rendering is disabled. Otherwise, the settings for the application components associated with the graphical object are considered to determine whether hardware rendering is requested or affirmatively disabled within any of the relevant components (308). If a subcomponent hierarchy is in use, such as the one described above, then inheritance rules may be used to determine what setting applies.

Once the hints, in conjunction with the signals associated with relevant elements of the application components, are processed to determine the state of hardware accelerated rendering, the graphical object is rendered with or without hardware acceleration as determined (310).

Although the process 300 is given in terms of a request for rendering a graphical object, in some implementations, the procedure may be performed on a per-view basis—that is, further requests for rendering within the same view during the same run of an application use the same hardware acceleration settings. In some embodiments, certain aspects of the determinations discussed herein may be performed at different times relative to the execution of an application. For example, some determinations may be made and set the first time an application is executed following initialization of an operating system, some determinations may be made upon initial execution of the application, some made upon initialization of a specific visual element within the application, some made at runtime when a specific graphical object is submitted to be rendered, and some made upon the failure of an object to correctly render. Further alterations in hardware accelerated rendering settings may occur based on further events, signals, and data encountered by the system.

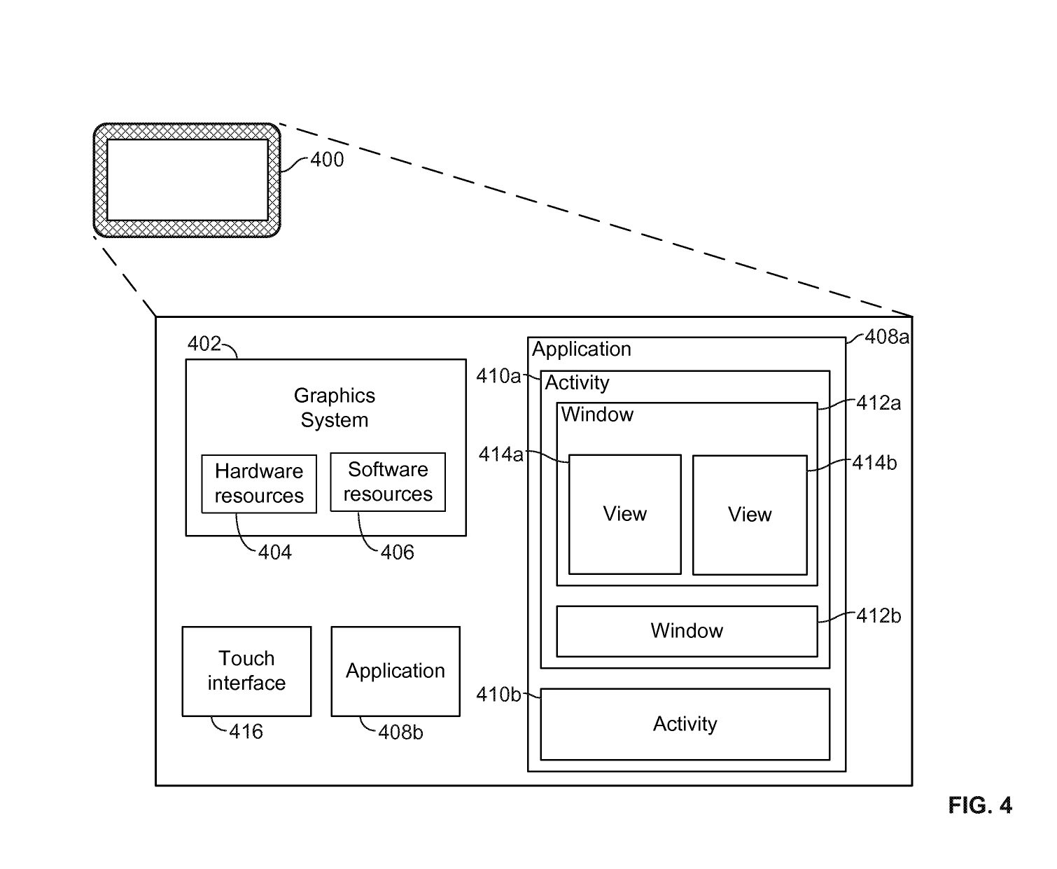

FIG. 4 shows a tablet computing device 400 as one example of a computing system within which hierarchical settings and hints may be used in determining when to use hardware resources to accelerate graphics rendering. The device 400 may be any computing device that includes at least one dedicated hardware resource available for processing graphics (such as a GPU) in addition to the generalized resources used for other computer processes (such as a CPU). Although the device 400 is shown and described as a tablet computer having a touch interface, any appropriate computing system having hardware accelerated rendering may benefit from implementations disclosed herein.

A graphics system 402, responsible for managing the resources and environment underlying all display on the device 400, includes both hardware resources 404 and software resources 406 for rendering displays associated with applications 408a-d. The graphics system may be a known API such as OpenGL, or a custom or proprietary system capable of managing the resources of the device 400. The hardware resources 404 may include a graphics processing unit (GPU) or other resources that can be dedicated to improving graphics rendering by their management and allocation. The software resources may include management processes for allocating and using generalized resources (such as the CPU, system RAM, etc) for drawing, rendering, processing, and displaying graphics on the system.

A visual element hierarchy is illustrated by the application 408a. An application 408a has multiple activities, including activities 410a and 410b. The activity 410a has windows including the windows 412a and 412b. The window 412a has multiple views including the views 414a and 414b. The application 408b, the activity 410b, and the window 412b may each also have one or more subcomponents that are not shown.

The graphics system 402 interacts with any of these visual elements 408, 410, 412, 414 in order to render graphical objects for display on the computing device 400. Some components are rendered including hardware resources 404, while other components may be rendered using only software resources 406. Various implementations as described in the present disclosure may be used by the graphics system 402 to determine when to use which resources.

Further components, such as a touch interface 416, may interact with the graphics system 402 as well as the applications 408a and 408b. Other components may interact with the applications 408a and 408b to provide additional capabilities such as online access and data storage.

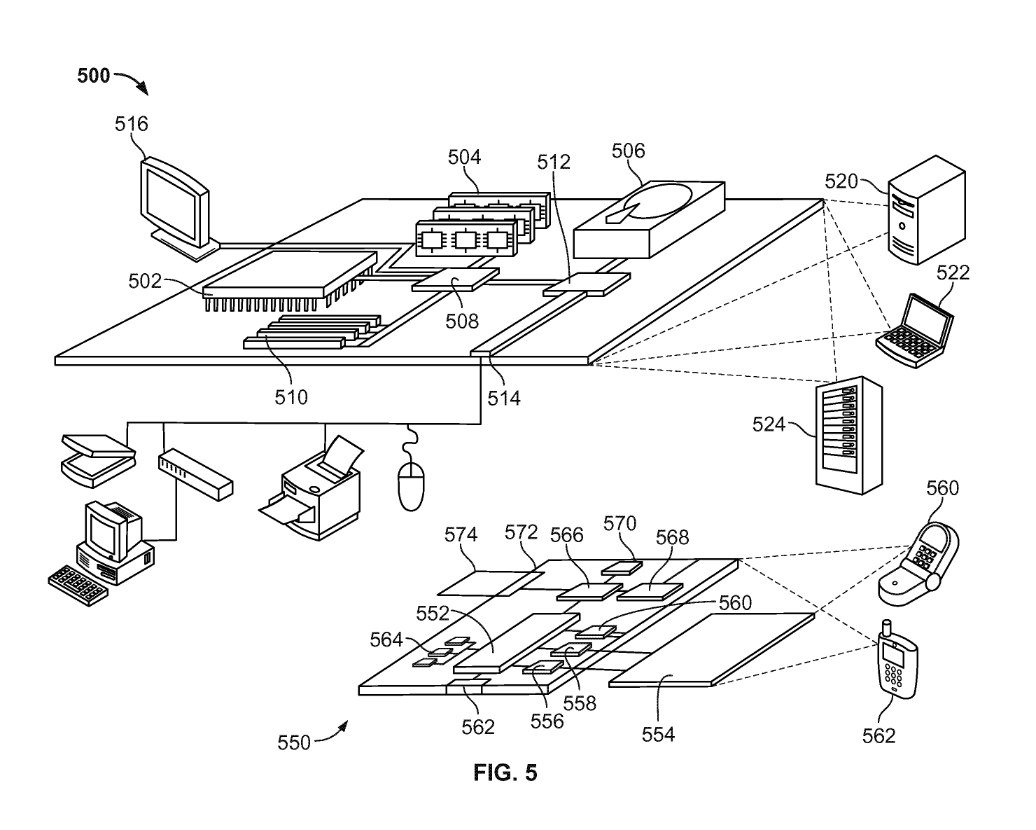

FIG. 5 shows an example of a generic computer device 500 and a generic mobile computer device 550, which may be used with the techniques described here.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, tablet computers and other similar computing devices. The components shown here, their connections and relationships, and their functions, are meant to be exemplary only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving a request for rendering a graphical object associated with a component of a computer system, the component being associated with an identifier that hardware accelerated rendering be used in conjunction with the component;
referencing a hint that identifies a condition under which hardware accelerated rendering should not be used;
determining that the condition of the hint is met with respect to the request for rendering the graphical object; and
rendering the graphical object without hardware accelerated rendering based on determining that the condition of the hint is met with respect to the request.

2. A computer-implemented method comprising:
receiving a first request for rendering a first graphical object associated with a component of a computer system, the first graphical object also associated with a first subcomponent of the component;
receiving a second request for rendering a second graphical object associated with the component of the computer system, the second graphical object also associated with a second subcomponent of the component;
identifying a hardware accelerated rendering signal of the component, the signal requesting either that graphical objects associated with the component be rendered with hardware acceleration or that graphical objects associated with the component be rendered without hardware acceleration;
rendering the first graphical object in accordance with the hardware accelerated rendering signal of the component;
identifying a hardware accelerated rendering override signal of the second subcomponent, the override signal identifying that graphical objects associated with the subcomponent be rendered contrary to the hardware acceleration setting specified by signal of the component; and
rendering the second graphical object contrary to the hardware accelerated rendering signal of the component.

3. The method of claim 2, wherein the component comprises an application, and the first and second subcomponents are each either an activity, a window, or a view of the application.

4. The method of claim 2, wherein the component comprises an activity of an application, and the first and second subcomponents are each either a window or a view of the activity.

5. The method of claim 2, wherein the component comprises a window of an activity within an application, and the first and second subcomponents are views of the window.

6. A system comprising:
one or more computers and one or more storage devices storing instructions that are operable, when executed by the one or more computers, to cause the one or more computers to perform operations comprising:
receiving a request for rendering a graphical object that is associated with a component of a computer system, the component including a request that hardware accelerated rendering be used in conjunction with the component;
referencing a hint that comprises a condition under which hardware accelerated rendering should not be used;
determining that the condition of the hint is met with respect to the request for rendering the graphical object; and
rendering the graphical object without hardware accelerated rendering based on determining that the condition of the hint is met with respect to the request.

7. A system comprising:
one or more computers and one or more storage devices storing instructions that are operable, when executed by the one or more computers, to cause the one or more computers to perform operations comprising:
receiving a first request for rendering a first graphical object associated with a component of a computer system, the first graphical object also associated with a first subcomponent of the component;
receiving a second request for rendering a second graphical object associated with the component of the computer system, the second graphical object also associated with a second subcomponent of the component;
identifying a hardware accelerated rendering signal of the component, the signal requesting either that graphical objects associated with the component be rendered with hardware acceleration or that graphical objects associated with the component be rendered without hardware acceleration;
rendering the first graphical object in accordance with the hardware accelerated rendering signal of the component;
identifying a hardware accelerated rendering override signal of the second subcomponent, the override signal requesting that graphical objects associated with the subcomponent be rendered contrary to the hardware acceleration setting specified by signal of the component; and
rendering the second graphical object contrary to the hardware accelerated rendering signal of the component.

8. The system of claim 7, wherein the component is an application, and the first and second subcomponents are each either an activity, a window, or a view of the application.

9. The system of claim 7, wherein the component is an activity of an application, and the first and second subcomponents are each either a window or a view of the activity.

10. The system of claim 7, wherein the component is a window of an activity within an application, and the first and second subcomponents are views of the window.

11. A non-transitory computer-readable medium storing software comprising instructions executable by one or more computers which, upon such execution, cause the one or more computers to perform operations comprising:
receiving a request for rendering a graphical object associated with a component of a computer system, the component including a request that hardware accelerated rendering be used in conjunction with the component;
referencing a hint comprising a condition under which hardware accelerated rendering should not be used;
determining that the condition of the hint is met with respect to the request for rendering the graphical object; and
rendering the graphical object without hardware accelerated rendering based on determining that the condition of the hint is met with respect to the request.

12. A non-transitory computer-readable medium storing software comprising instructions executable by one or more computers which, upon such execution, cause the one or more computers to perform operations comprising:
receiving a first request for rendering a first graphical object associated with a component of a computer system, the first graphical object also associated with a first subcomponent of the component;
receiving a second request for rendering a second graphical object associated with the component of the computer system, the second graphical object also associated with a second subcomponent of the component;
identifying a hardware accelerated rendering signal of the component, the signal requesting either that graphical objects associated with the component be rendered with hardware acceleration or that graphical objects associated with the component be rendered without hardware acceleration;
rendering the first graphical object in accordance with the hardware accelerated rendering signal of the component;
identifying a hardware accelerated rendering override signal of the second subcomponent, the override signal requesting that graphical objects associated with the subcomponent be rendered contrary to the hardware acceleration setting specified by signal of the component; and
rendering the second graphical object contrary to the hardware accelerated rendering signal of the component.

13. The medium of claim 12, wherein the component comprises an application, and the first and second subcomponents are each either an activity, a window, or a view of the application.

14. The medium of claim 12, wherein the component comprises an activity of an application, and the first and second subcomponents are each either a window or a view of the activity.

15. The medium of claim 12, wherein the component comprises a window of an activity within an application, and the first and second subcomponents are views of the window.
